(19) United States
(12) Patent Application Publication
(10) Pub. No.: US 2025/0392608 A1
(43) Pub. Date: Dec. 25, 2025

(54) MACHINE-LEARNING BASED SECURITY EVENT DETECTION

(71) Applicant: Stripe, Inc., South San Francisco, CA (US)

(72) Inventors: Chiranth Manjunath HEGDE, Seattle, WA (US); Efstathios VAFEIAS, San Francisco, CA (US)

(21) Appl. No.: 18/761,204

(22) Filed: Jul. 1, 2024

(30) Foreign Application Priority Data
Jun. 25, 2024 (GR) 000002141

(51) Int. Cl. H04L 9/40; G06Q 20/40

(52) U.S. Cl. CPC H04L 63/1425; G06Q 20/4016; H04L 2463/102

(57) ABSTRACT

Systems and methods provide for security event detection using machine learning. Event data items are processed using a first machine-learning model to generate an encoding for each corresponding event data item. Each encoding is processed using a second machine learning model to generate a classification indicating whether the corresponding event is fraudulent. A security event is determined based on some of the generated classifications. In response to detecting the security event, an event processing rate is adjusted.

### CROSS REFERENCE TO RELATED APPLICATIONS

This application claims the benefit of Greek Patent Application No. 000002141 filed Jun. 25, 2024, the entirety of which is incorporated herein by reference.

### TECHNICAL FIELD

The disclosure relates to security event detection and, more particularly, to machine-learning based security event detection.

### BACKGROUND

The rise of digital payments comes with increased risk of financial fraud, challenging both consumers and businesses. Malicious actors exploit vulnerabilities of digital payment systems to make unauthorized and illegal transactions, leading to significant financial losses and compromising consumer trust. Financial institutions and merchants have implemented various security measures to counter financial frauds. These measures include sophisticated fraud detection algorithms that monitor transactions for unusual activity, encryption of data to protect sensitive information, and two factor authentication processes that require verification steps during the transaction process. Despite these efforts, there is need for continuous advancement in security technologies as malicious actors constantly develop new methods to bypass existing protections.

### BRIEF DESCRIPTION OF THE FIGURES

For a better understanding of the various described implementations, reference should be made to the Detailed Description below in conjunction with the following figures in which like reference numerals refer to corresponding parts throughout the figures.

FIG. 1 illustrates an example network environment in accordance with one or more implementations described herein.

FIG. 2 illustrates an example computing architecture for a system in accordance with one or more implementations described herein.

FIG. 3A illustrates an example machine learning model in accordance with one or more implementations described herein.

FIG. 3B illustrates an example machine learning model in accordance with one or more implementations described herein.

FIG. 4 illustrates an example machine learning model in accordance with one or more implementations described herein.

FIG. 5 illustrates an example of detecting card testing attacks in accordance with one or more implementations described herein.

FIG. 6 illustrates a flowchart of an example process of detecting card testing attacks in accordance with one or more implementations described herein.

FIG. 7 illustrates a flowchart of an example process of training a first machine learning model in accordance with one or more implementations described herein.

FIG. 8 illustrates a flowchart of an example process of training a second machine learning model in accordance with one or more implementations described herein.

FIG. 9 illustrates an example electronic system with which aspects of the subject technology may be implemented in accordance with one or more implementations described herein.

The details above in the Brief Description of the Drawings are intended to describe only some aspects relating to certain implementations of the innovations herein and should not be deemed in any way limiting with respect to requiring or omitting any aspect for implementations to be claimed or otherwise limiting the disclosure or implementations keeping with its scope or spirit.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other implementations. In some implementations, structures and components are shown in block diagram form to avoid obscuring the concepts of the subject technology.

Merchants, including online and physical stores as well as service providers, offer their goods and services to consumers in a variety of ways. One common method includes direct sales through an online storefront. Consumers can visit the merchant's website, browse products, and make purchases directly. Merchants may also opt for third-party commerce platforms that manage all aspects of customer billing and account related operations. These platforms facilitate transaction processing, manage subscription changes, allow updates to payment method, and provide access to billing histories.

However, a merchant's online platform may be susceptible to security vulnerabilities. One such vulnerability is a card testing attack. It is a type of card not present (“CNP”) fraud that occurs when a credit or debit card number is used without authorization to make purchases in situations where the card is not physically presented, such as online transactions, call center order, etc. Detection of CNP fraud is challenging because the merchant cannot physically verify the card, or the identity of the card holder. Card testing attack begins with malicious actors obtaining stolen credit and/or debit cards. Using sophisticated digital tools such as bots or scripts, these malicious users are able to automate and execute multiple CNP transaction authorizations on the merchant's website in order to determine the validity of the cards. If some of the cards are valid, the malicious actors can use the cards for purchases or resell the card details to other malicious actors.

Detecting card testing attacks can be challenging for several reasons making it difficult for merchants and commerce platforms to prevent fraud effectively. Some of the challenges include the use of bots to rapidly submit a large number of transactions. These transactions can flood the payment processing system making it hard to differentiate between legitimate and fraudulent activity. Additionally, card testing is performed for a small time period making it difficult for the transaction processing system to detect and react to such attacks. Typically, these transactions process low value payments to minimize detection as most fraud detection systems are configured to flag high-value payments. To carry out such attacks, malicious actors may use proxy servers and (Virtual Private Networks) VPNs, making the transactions appear legitimate. Tactics such as mixing the card testing transactions with legitimate customer traffic makes it even more difficult to detect card testing attacks.

Artificial Intelligence including Machine Learning (ML) offers powerful tools for detecting card testing attacks by analyzing patterns and anomalies in transaction data that may be invisible to human analysts. By training models on historical data, ML algorithms can be used to differentiate between normal and fraudulent transaction behaviors. These ML models can continuously update their understanding as they process new transaction, enhancing their accuracy over time.

In the subject system, a server is configured to train and implement ML models to detect card testing attacks. The ML models include a first ML model and a second ML model that are used to transform the transaction data and to classify the transformed data to indicate whether the respective transactions are fraudulent or legitimate. When a sequence of transactions is classified as fraudulent, the payment server 130 determines that the merchant corresponding to those transactions is experiencing a card testing attack. Upon confirming that the merchant is experiencing a card testing attack, the server takes steps to contain and mitigate the attack thereby protecting the merchant from potential financial losses and preserving the integrity of the payment ecosystem. This system not only aids in immediate threat neutralization but also enhances overall security measures of all transactions processed through the server.

The subject system also provides for efficient processing of large volumes of transactions making it well-suited for high-throughput environments. Compared to traditional rule-based or heuristic methods, which often require extensive memory storage to store rules, patterns and numerous intermediate computations, the subject system can include compression techniques to lower the memory requirement by reducing the size of the model files without sacrificing accuracy and speed, thereby providing for efficient use of memory and/or power resources. By using ML models, the subject system automates the process of determining card testing attacks reducing the need for manual intervention. The automation further allows the subject system to detect card testing attacks in real time thereby minimizing the losses suffered due to such kind of attacks.

Compared to traditional rule-based or heuristic methods, the subject system learns and adapts to new patterns and techniques used in card testing attacks. For example, the ML models implemented by the subject system can be continuously re-trained on both legitimate and fraudulent transactions to recognize new patterns enhancing the system's performance in distinguishing fraudulent and legitimate transactions. The context aware nature of the ML models in detecting card testing attacks allows the subject system to perform complex multi-dimensional analysis of transactional data for detecting card testing attacks. This allows the subject system to reduce the number of false positive in determining the fraudulent transactions over time.

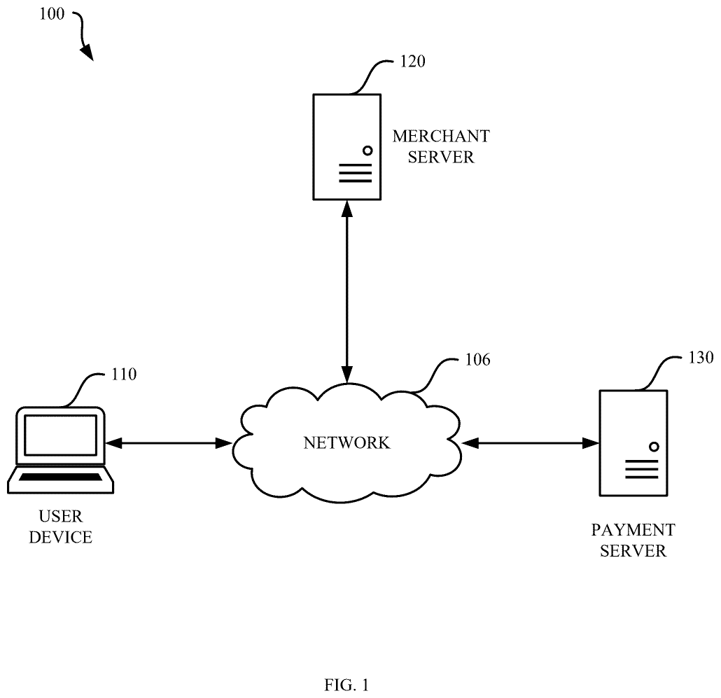

FIG. 1 illustrates an example network environment 100 in accordance with one or more implementations of the subject technology. Not all of the depicted components may be used in all implementations, however, and one or more implementations may include additional or different components than those shown in the figure. Variations in the arrangement and type of the components may be made without departing from the spirit or scope of the claims as set forth herein. Additional components, different components, or fewer components may be provided.

The network environment 100 includes a user device 110, a merchant server 120 and a payment server 130. The network 106 may communicatively (directly or indirectly) couple the user device 110, the merchant server 120 and the payment server 130. In one or more implementations, the network 106 may be an interconnected network of devices that may include, or may be communicatively coupled to, the Internet. For explanatory purposes, the network environment 100 is illustrated in FIG. 1 as including the user device 110, a merchant server 120 and a payment server 130; however, the network environment 100 may include any number of electronic devices and any number of servers.

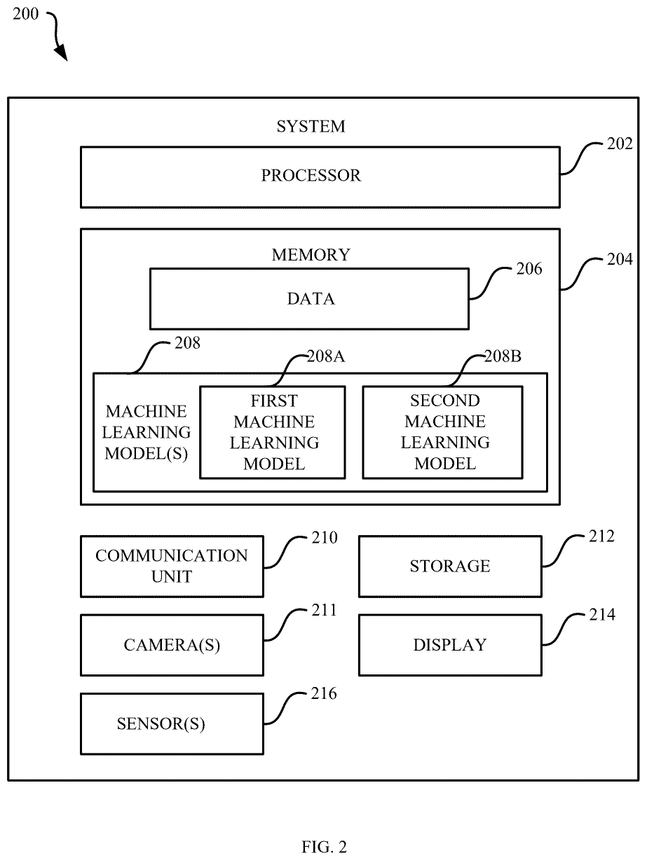

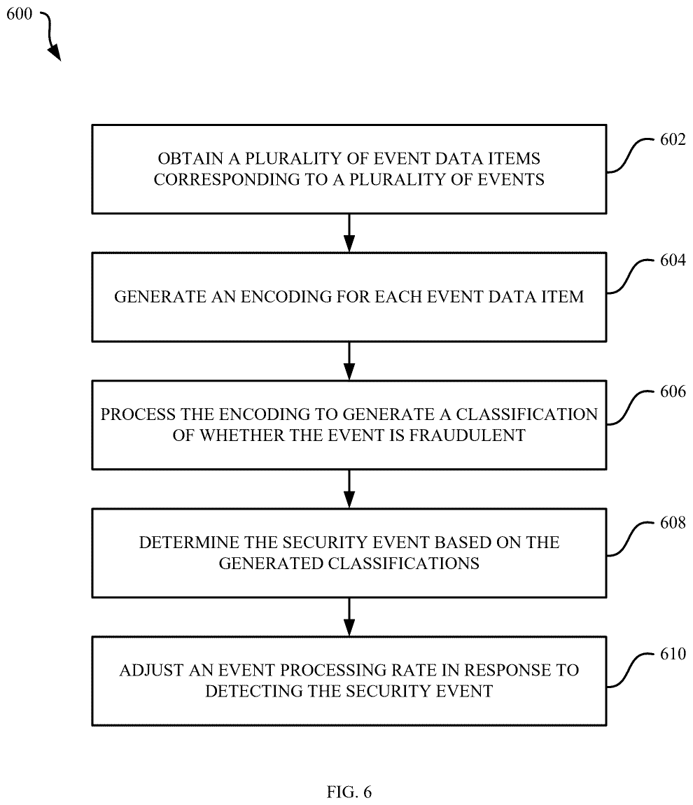

The user device 110 may be, for example, a desktop computer, a portable computing device such as a laptop computer, a smartphone, a peripheral device (e.g., a digital camera, headphones), a tablet device, a wearable device such as a watch, a band, and the like. In FIG. 1, by way of example, the user device 110 is depicted as a laptop. The user device 110 may be, and/or may include all or part of, the systems discussed below with respect to FIG. 2 and/or FIG. 6.

The merchant server 120 can be owned or operated by a merchant to provide a digital marketplace which offers sale of products and services which are collectively referred to herein as “products”. For example, the merchant server 120 can a webserver hosting a website that lists all of the products of a merchant. The merchant server 120 allows merchants to manage product listings, process transactions, handle customer enquiries etc. The merchant server 120 also enables customers to browse, select and purchase items online using a user interface accessible using the user device 110.

The payment server 130 can be owned and operated by a payment service provider that provides a transaction processing system (or a platform) for delivering transaction processing services to the merchants. The payment processing system of the payment server 130 can support a variety of payment methods such as credit cards, debit cards, and digital wallets. The payment server 130 also implements security protocols including encryption and compliance with, e.g., Payment Card Industry Data Security Standard (PCI DSS) standards to safeguard sensitive information and protect against data breaches insecure and fraud. To protect against financial fraud, the payment server 130 can train and deploy machine learning models specifically tailored for fraud prevention, as is discussed further below.

FIG. 2 illustrates an example system 200 in accordance with some implementations of the subject technology. In an example, the system 200 may be implemented in the user device 110, the merchant server 120 or the payment server 130. In another example, the system 200 may be implemented either in a single device or in a distributed manner in a plurality of devices, the implementation of which would be apparent to a person skilled in the art.

In an example, the system 200 may include a processor 202, memory 204 (memory device) and a communication unit 210. The memory 204 may store data 206 and one or more machine learning models 208A. In an example, the system 200 may include or may be communicatively coupled with a storage 212. Thus, the storage 212 may be either an internal storage or an external storage. In the example of FIG. 2, the system 200 includes one or more camera(s) 211, a display 214, and one or more sensors(s) 216. Sensor(s) 216 may include location sensors (e.g., satellite positioning system sensors), motion sensors (e.g., inertial sensors), and/or depth sensors (e.g., stereo cameras, LIDAR sensors, radar sensors, time-of-flight sensors, or the like).

In an example, the processor 202 may be a single processing unit or multiple processing units. The processor 202 may be implemented as one or more microprocessors, microcomputers, microcontrollers, digital signal processors, central processing units (CPUs), graphics processing units (GPUs), neural processors, specialized processors, e.g., for training and/or evaluating machine learning models, such as large language models, state machines, logic circuitries, and/or any devices that manipulate signals based on operational instructions. Among other capabilities, the processor 202 is configured to fetch and execute computer-readable instructions and data stored in the memory 204.

In an example, the communication unit 210 may include one or more hardware units that support wired or wireless communication between the processor 202 and processors of other computing devices, and/or for communication over a telecommunication network.

The memory 204 may include any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

The data 206 may represent, amongst other things, a repository of data processed, received, and generated by one or more processors such as the processor 202. One or more of the aforementioned components of the system 200 may send or receive data, for example, using one or more input/output ports and one or more communication units.

As described above, the payment server 130 implements the transaction processing system for delivering transaction processing services to entities such as merchants. When a customer initiates an event such as payment transaction using payments methods (e.g., credit cards, debit cards, or digital wallets) on a merchant website, the merchant server 120 captures the event data item for each individual event. Each event data item can include details of the corresponding transaction event. For example, the event data item for a transaction can include an amount, a date, a time, merchant details, along with sensitive customer data like card number, security codes, etc. The event data items are then securely transmitted to the payment server 130 using encryption methods and secure communication protocols.

Once the payment server 130 receives the event data items, the payment server 130 processes the event data items to carry out authorization and the settlement process. The payment server 130 transmits details of the event data items to the respective bank or card network for authorization. In response, the respective back or the card network verifies the event i.e., transaction against the funds available with the card holder and the validity of the event. After approval, an authorization code is sent back to the merchant completing the transaction approval process. Following this, the settlement process begins where the actual transfer of funds from the customer's account to the merchant's account is facilitated usually within a few business days.

Since the event data items are transmitted via the payment server 130, the payment server 130 can implement one or more techniques to detect fraud. In an example, the machine learning (ML) models 208, may include one or more machine learning models. For example, the models 208 can include a first ML model 208A that is used to predict missing features in the event data items. Once these features are predicted, the first ML model 208A encodes the features to generate an encoding. This process is for transforming raw data into a format that can effectively be analyzed and utilized by a subsequent machine learning process. The ML models 208 can also include a second ML model 208B to process the encoding generated by the first ML model 208A to classify the encoding as fraudulent or legitimate. By doing so, the second ML model 208B determines whether the event i.e., the transaction associated with the encoding, is a fraudulent or a legitimate transaction. Since card testing attacks are performed using a large number of events, classification of a few events as fraudulent may serve as a sufficient indication of a merchant that is under a card testing attack. By effectively segmenting the detection process into these two stages of data preparation and fraud detection, the payment server 130 enhances the accuracy and efficiency of identifying fraudulent transactions. In an example, the machine learning model(s) 208 may be trained using training data (e.g., included in the data 206 or other data) and may be implemented by the processor 202 for performing one or more of the operations, as described further below.

In some implementations, the event data item can include a complex array or vector of features that may include transaction amount, timestamp, bank identification number (BIN), merchant category, geographical location, data identifying the user device 110 (e.g., hardware and software information), Internet Protocol (IP) address and more. The initial set of features (referred to as the first set of features) gathered from the event data items and various sources within the transaction process serves as an input for the first ML model 208A. For example, the first set of features can include the transaction amount, timestamp, bank identification number (BIN), merchant category, and IP address of the user device 110, etc. In some implementations, the first ML model 208A is a neural network designed using a transformer architecture and trained to process the first set of features to generate a second set of predicted features. The transformer structure of the first ML model 208A may include multiple layers of self-attention mechanism that allow the model to process the first set of features to generate the second set of predicted features. The second set of predicted features can include one or more features that were either missing from the array of features of the event data items or one or more refined features that are derived from the first set of features such as transaction velocity, spending patterns, location of prior transaction, timestamp of prior transaction, etc. These engineered features are designed to capture deeper insights about the transactions that are not immediately apparent in the raw data.

After generating the first set of features and the second set of predicted features, the first ML model may further process the features to generate an encoding. The first ML model 208A can process the first set of features and the second set of features through its multiple layers each designed to transform the first set of features and the second set of predicted features into encodings that may seem abstract. In some implementations, the encodings generated by the first ML model 208 can be a vector of one or more dimensions.

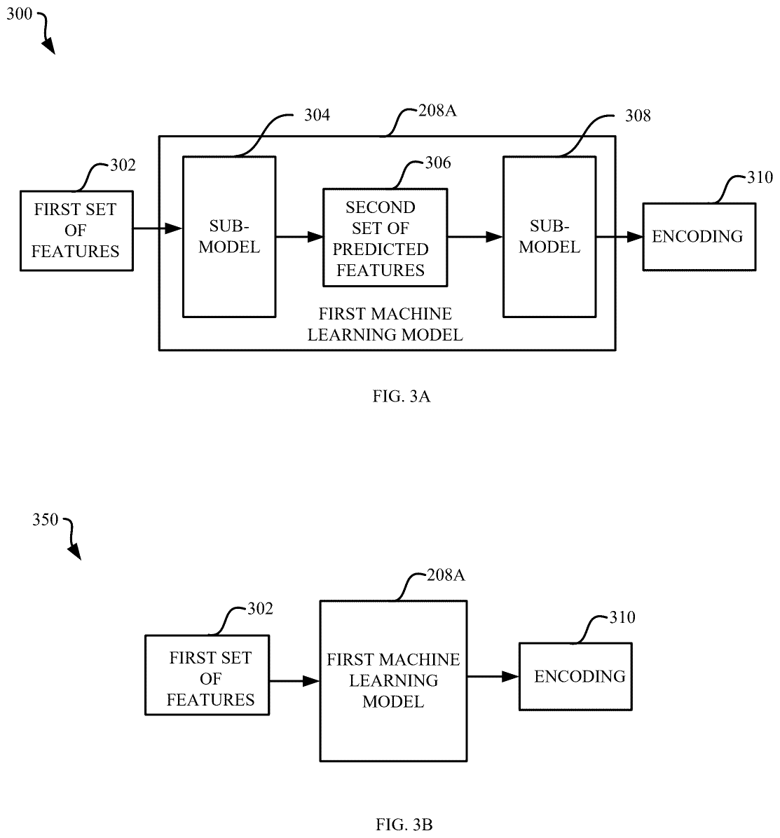

FIG. 3A is a block diagram illustrating an example of a first ML model 208A implemented by the payment server 130 for predicting the second set of predicted features and transform the first set of features and the second set of predicted features into encodings. As described above, the first set of features are available to the payment server 130 and are extracted from the event data items transmitted by the merchant server 120 and the second set of predicted features are features that were missing in the event data items. For example, the first set of features 302 includes the transaction amount, timestamp, bank identification number (BIN), merchant category, and IP address of the user device 110 and the second set of predicted features 306 includes the customer browser type, the time to complete the transaction, the corporate card indicator, the visibility status of the transaction, etc. The second set of predicted features 306 can also include one or more refined features that are derived from the first set of features such as transaction velocity, spending patterns, location of prior transaction, timestamp of prior transaction, etc. In this example, the first ML model 208A includes two sub models 304 and 308.

The sub model 304 can be a neural network designed using a transformer architecture and trained to process the first set of features 302 to generate a second set of predicted 306 features. In some implementations, the architecture of the sub model 304 is designed to predict a pre-specified number of predicted features. For example, the sub model 304 can include five output nodes, each of which can generate a feature. In this example, the predicted feature is a binary feature. An example of a binary predicted features is a flag variable indicating whether the payment method (e.g., a credit or a debit card) is blocked. In other implementations, the sub model 304 can sequentially generate the predicted features. For example, the model 304 can execute five iterations during prediction, and during each prediction, the model 304 can generate a predicted features of the second set of predicted features.

The sub model 308 can be a neural network designed using a transformer architecture and trained to process the first set of features 302 and the second set of predicted features 306 to generate an encoding. The payment server 130 can provide the first set of features 302 as input to the sub-model 304 to generate the second set of predicted features 306. The payment server 130 then provides the first set of features 302 and the second set of predicted features 306 as input to the sub-model 308 to generate the encoding 310 which is a compressed vector representation of the first set of features 302 and the second set of predicted features 306 in one or more dimensions.

FIG. 3B is a block diagram illustrating another example of a first ML model 208A implemented by the payment server 130 for transforming the first set of features into encodings. In this example, the first ML model 208A is a neural network designed using a transformer architecture and trained to process the first set of features 302 to generate an encoding. In such implementations, the prediction of missing features i.e., the second set of predicted features can be internal to the first ML model 208A. In this example, the payment server 130 can provide the first set of features 302 as input to the first ML model 208A to generate the encoding 310. As described before, the encoding 310 generated by the first ML model 208 can be a compressed vector of one or more dimensions.

In some implementations, the second machine ML model 208B is a neural network designed using a transformer architecture and trained to process the encodings generated by the first ML model 208A to indicate whether the transaction associated with the encoding is fraudulent. The second ML model 208B can process the encodings generated by the first ML model 208A to classify the encodings as fraudulent or legitimate. By doing so, the second ML model 208B determines whether the transaction associated with the encodings are fraudulent or legitimate transactions. For example, the second ML model 208B can generate a label “fraudulent” if the second ML model 208 determines that the transaction is fraudulent. As for another example, the second ML model 208B can generate a label “legitimate” if the second ML model 208 determines that the transaction is not fraudulent.

However, since card testing attacks are performed using a large number of transactions, classification of a single transactions as fraudulent is not sufficient to indicate that an entity is experiencing a security event such as a card testing attack. To address this issue the second ML model 208B is configured to analyze the context of events in a sequential manner by processing events in the order they occur. By considering the sequence of events and the classification of prior events, the second ML model 208B can identify patterns that are indicative of card testing attacks such as rapid succession of failed transactions or a high volume of small transactions in a short time period. This temporal analysis of the second ML mode 208B enhances the system's ability to differentiate between isolated fraudulent events and coordinated fraudulent events, thus providing a robust security solution for detecting and responding to card testing attacks.

In some implementations, to classify a particular event in a sequence of events, the second ML model 208B may be configured to process the encodings generated for one or more prior events in the sequence of events. For example, the second ML model 208B can process the encodings generated by the first ML model 208 in the order of their associated timestamps. While generating a classification for a particular event, the second ML model 208B can process the encodings of the one or more prior events. In some implementations, the number of prior encodings that can be used by the second ML model 208B is pre-specified. For example, if the pre-specified number is set to one, the second ML model 208B can use the encoding generated for the prior event. For example, if the pre-specified number is set to three, the second ML model 208B can use the encodings generated for previous three events. In some implementations, the second ML model 208B can use the encodings generated for each of the prior events in a sequence of events. For example, if there are ten events, and the second ML model 208B is processing the encoding generated by the first ML model 208A for the eighth event, the second ML model 208B can also process the encodings generated for each of the prior seven events.

In some implementations, the payment server 130 can determine whether the merchant is experiencing a security event by analyzing the classifications of the sequence of events. The payment server 130 can evaluate a sequence of events and calculate a proportion of events that have been classified as fraudulent. The number of events that are evaluated by the payment server 130 can be pre-specified. For example, the proportion of events that are classified as fraudulent can be calculated as a percentage of events. For example, the payment server 130 can process a pre-specified number of events associated with the merchant and calculate the percentage of events that were classified as fraudulent. If the percentage of the fraudulent events exceeds a pre-specified threshold, the payment server 130 can determine that the entity i.e., the merchant's website and potentially the merchant server 120 have been compromised thus identifying a security event experienced by the entity.

In some implementations, the number of events that are evaluated for determining whether the merchant is experiencing a security event may be dynamically determined by the payment server 130. The adaptability of the payment server 130 allows the payment server 130 to optimize its assessment for maximum accuracy. In some implementations, rather than focusing on the number of transactions, the payment server 130 can evaluate all events from a merchant over a pre-specified period of time. In such implementations, payment server 130 can process all events over the pre-specified period of time and calculate the percentage of events that were classified as fraudulent. If the percentage of the fraudulent events exceeds a pre-specified threshold, the payment server 130 can determine that the merchant is compromised thus identifying a security event.

In response to determining that an entity is experiencing a security event, the payment server 130 can adjust the event processing rate. For example, the payment server 130 may reduce the rate of transaction processing from the entity to mitigate the security event. For example, if the merchant server 120 is transmitting ten transactions per second for an entity, and if the payment server 130 determines that the entity is experiencing a security event, the payment server 130 can reduce the transaction processing rate to one transaction per second. In some implementations, the payment server 130 can implement other types of restrictions to prevent and/or mitigate the security event. For example, the payment server 130 can determine whether the fraudulent events are submitted by bots or scripts based on the first set of features and the second set of features. In response to determining that the fraudulent events are submitted by bots or scripts, the payment server 130 can block further events issued by the bots or scripts and notify the entity.

In some implementations, the payment server 130 may train the first ML model 208A and the second ML model 208B prior to deploying the models to detect security events. The payment server 130 can generate an event dataset (e.g., a training dataset) to train the first ML model 208A and the second ML model 208B. To generate the event dataset, the payment server 130 can obtain multiple event data items from the merchant server 120 where each event data item is recorded by the merchant server 120 in response to an event. For example, the payment server 130 can obtain event data items for each event recorded by the merchant server 120 over a period of time.

The payment server 130 can then catalog each event that includes both successful and failed events as a respective training sample to generate the event dataset. To generate the event dataset, the payment server 130 can extract a first set of training features from the event data items. For example, payment server 130 can extract the transaction amount, the timestamp, the bank identification number (BIN), the merchant category, the IP address of the user device 110, etc., and include them into the first set of features. Since these events correspond to historical transactions, the payment server 130 can obtain a second set of training features from one or more other sources such as the merchant server 120, the bank, the card network, etc. Note that the second set of training features are real features of historical events. If the second set of features predicted using the first ML model 208A include derived features from the first set of features, the merchant server 120 can process the first set of training features to generate the second set of training features. Each training sample also includes a timestamp indicating the timestamp of the event. In some implementations, the payment server 130 can arrange the training samples in the event dataset according to their timestamps. For example, the training samples are arranged in a sequence of their respective events. In some implementations, the payment server 130 computes the time difference between two successive events in a sequence using the timestamps and include the time difference as an additional attribute to exploit the temporal dependency of consecutive events so as to differentiate between isolated fraudulent events and coordinated fraudulent events.

In some implementations, the payment server 130 can assign a label to each training sample indicating whether the corresponding event was legitimate or fraudulent. For example, if a transaction event is fraudulent, the server can assign a label “fraudulent” to the respective training sample that represents the transaction. As for another example, if a transaction event is legitimate, the server can assign a label “legitimate” to the respective training sample that represents a legitimate transaction. As these training samples correspond to historical transactions, the information regarding the transaction being legitimate or fraudulent is obtained from one or more sources such as the bank, the card network, or the merchant server 120. This process ensures that the ML models are trained on accurately labeled data enhancing their ability to detect fraudulent transactions in future.

To train the first ML model 208A, the payment server 130 may iteratively provide the first set of training features of the training samples to train the first ML model 208A to generate a corresponding second set of predicted training features. After generating the second set of predicted training features, the payment server 130 can use the first ML model 208A to process the first set of training features and the corresponding second set of predicted training features to generate a first encoding.

The payment server 130 may then iteratively provide the first set of training features and the second set of training features of the training samples to the first ML model 208A to generate a second encoding. Note that the first encoding is based on the second set of predicted training features and the second encoding is based on the second set of training features that were obtained by the payment server 130 from one or more sources and correspond to the real features for the corresponding transaction events. In some implementations, the payment server 130 can compare the first encoding and the second encoding and compute a loss value based on a loss function (e.g., Cross-entropy loss function) and alter the parameters of the first ML model 208A based on the loss value. The training process is further explained with reference to the first ML model 208A introduced in FIG. 3A and FIG. 3B.

In some implementations, the training process of the first ML model 208A introduced in FIG. 3A, can include training the sub model 304 and the sub model 308. To train the sub model 304, the payment server 130 can iteratively provide the first set of training features as an input to the sub model 304. The sub model 304 can process the input to generate a corresponding second set of predicted training features. For example, the sub model 304 can process the first set of training features such as the transaction amount, timestamp, bank identification number (BIN), merchant category, and IP address of the user device 110 to generate the second set of predicted training features such as the customer browser type, the time to complete the transaction, the corporate card indicator, the visibility status of the transaction, etc. As described before, the events of the event dataset correspond to historical transactions allowing the payment server 130 to obtain the second set of training features from one or more other sources such as the merchant server 120, the bank, the card network, etc. Since the second set of training features are real features of the events, the payment server 130 can use a loss function (e.g., cross entropy loss) to compute a loss value by comparing the second set of predicted training features to the second set of training features. In other words, the payment server 130 compares the predicted features to the real features to compute the prediction error. The prediction error is provided back to the sub model 304 via back-propagation to adjust the parameters of the sub model 304.

Once the sub model 304 is trained, the payment server 130 can use the sub model 308 to process the first set of training features and the corresponding second set of predicted training features to generate a first encoding. The payment server 130 can then use the sub model 308 to process the first set of training features and the corresponding second set of training features to generate a second encoding. Note that the first encoding is based on the predicted features and the second encoding is based on the real features. The payment server 130 can compare the first encoding and the second encoding to compute a loss value based on a loss function (e.g., cross-entropy loss function) and alter the parameters of the sub model 308 based on the loss value.

In some implementations, the training process of the first ML model 208A introduced in FIG. 3B, can include processing the first set of training features from the event dataset to generate an encoding. In such implementations, the first ML model 208A is trained using a decoder that processes the encodings generated by the first ML model 208A to predict the corresponding first set of training features and the corresponding second set of training features. The payment server 130 can compare the second set of training features predicted by the decoder to the second set of training features of the event dataset to compute a loss value based on a loss function (e.g., cross-entropy loss function) and alter the parameters of the first ML model 208A based on the loss value.

The training process described above can also include providing the loss value as feedback to the ML models and adjusting the trainable parameters of the ML models based on the magnitude of the loss value. The payment server 130 may repeat the process iteratively using different training samples from the event dataset until the loss value is below a certain pre-threshold. The training process can further include fine tuning that involves adjusting hyperparameters, extending the training duration or enriching the training data set with more diverse examples.

The training objective of the first ML model 208A includes computing the loss value to ensure that the second set of predicted features by the first ML model 208A match the second set of training features. The training also includes providing the loss value as a feedback to the first ML model 208A and adjusting the trainable parameters of the first ML model 208A based on the magnitude of the loss value. The payment server 130 may repeat the process iteratively using different training samples from the event dataset until the loss value is below a certain pre-threshold. The training can further include fine tuning that involves adjusting hyperparameters, extending the training duration or enriching the training data set with more diverse examples.

In some implementations, to train the second ML model 208B, the payment server 130 can iteratively provide the first set of training features and the corresponding second set of predicted training features to the trained first ML model 208A to generate a third encoding. In some implementations, the payment server 130 can process the third encoding using a second ML model 208B to generate a predicted classification indicating whether the third encoding corresponds to an event that is legitimate or fraudulent. For example, the second ML model 208B generates a label by processing the third encoding. In an example, the labels can be “fraudulent” or “legitimate.”

In some implementations, the payment server 130 can iteratively use different training samples from the event dataset in a sequence according to their respective time stamps. By considering the sequence of events, the second ML model 208B can identify patterns that are indicative of card testing attacks such as rapid succession of failed transactions or a high volume of small transactions in a short time period. To learn such patterns, the payment server 130 can process a third encoding along with the encodings (e.g., third encodings) generated for one or more prior events i.e., while generating a classification for a third encoding that corresponds to a training sample with a respective timestamp, the second ML model 208B can process the respective third encodings of one or more prior training samples that are ordered according to their respective timestamps. As an example, assume that the second ML model 208B is configured to process two prior events while generating a classification for a training sample. In this example, while generating a classification for a training sample with a time stamp t, the second ML model 208B can process the third encoding of the training sample at timestamp t along with the third encoding generated for the training sample at timestamp t-1 and the third encoding generated for the training sample at timestamp t-2.

In some implementations, the payment server 130 can compare the predicted label by the second ML model 208B with the label from the training sample to compute a loss value based on a loss function (e.g., Binary cross-entropy loss function) and alter the parameters of the second ML model 208B based on the loss value. The training objective of the second ML model 208B includes computing the loss value to ensure that the predicted label generated by the second ML model 208B matches the true label of the training samples. The training also includes providing the loss value as feedback to the second ML model 208B and adjusting the trainable parameters of the second ML model 208B. The payment server 130 may repeat the process iteratively using different training samples from the event dataset until the loss value is below a certain pre-threshold. The training can further include fine tuning that involves adjusting hyperparameters, extending the training duration or enriching the training data set with more diverse examples.

In some implementations, the training objective also includes determining the optimum value for the number of prior events that can be processed by the second ML model 208B. In such implementations, the payment server 130, during each training iteration, can use the second ML model 208B to process the third encoding and generate multiple labels, each of which is based on a different number of prior events processed by the second ML model 208B. By doing so, the payment server 130 can iteratively filter out the optimum values for the number of prior events that can be processed in the subsequent iterations. As for another example, the payment server 130 can execute multiple instances of training the first ML model 208A and the second ML model 208B where each instance is based on a fixed number of prior events that can be processed by the second ML model 208B.

In some implementations, the second ML model 208B can process the encodings generated by the first ML model 208A into discretized vector representations. In such implementations, the second ML model 208B can process the encodings into a continuous latent space to generate a latent vector which is a form of a vector in an abstract N-dimensional space. The latent vector is then mapped to the nearest vector using a pre-defined codebook (e.g., a set of fixed-size vectors each of which can represent a discrete state in the latent space) though vector quantization. The nearest vector from the codebook is then selected based on a distance metric (e.g., Euclidean distance) to represent the respective event. This allows the payment server 130 to represent continuous features as discrete latent variables as it is more suited for classification tasks. Using a codebook of a set of fixed-size vectors also allows the payment server 130 to compress information resulting in memory efficiency. Further, the discrete nature of the codebook vectors acts as a regularizer and prevents the second ML model 208B from overfitting.

To determine whether an event is legitimate or fraudulent, the payment server 130 can compute the entropy of the selected codebook vector which is a measure of each codebook vector usage in representing the latent vectors. To calculate the entropy, the payment server 130 can determine the distribution of codebook vector usage to measure the uncertainty of the latent space representation. The payment server 130 can generate a probability distribution that provides a metric to determine tracking the frequency of each codebook vector usage. The payment server 130 can then calculate the entropy based on the probability of selecting the i-th codebook vector based on which the payment server 130 can determine whether an event is legitimate or fraudulent.

In some implementations, to determine whether an event is legitimate or fraudulent, the payment server 130 can evaluate the entropy of the codebook vector for each event. For example, if the entropy of a codebook vector representing an event is approximately equal to the average entropy, the payment server 130 can determine that the event is legitimate. However, if the entropy of a codebook vector representing an event is lower than a pre-determined baseline threshold, the payment server 130 can infer that the event maps to an infrequently used or unique codebook vector and determine that the event is fraudulent. If the entropy of a codebook vector representing an event is higher than a pre-determined ceiling threshold, the payment server 130 can infer that the event shows unusual variability or diversity and determine that the event is fraudulent.

In some implementations, the payment server 130 can determine whether the entity is experiencing a security event based on events that were classified as fraudulent. For example, the payment server 130 can evaluate a sequence of events and calculate a proportion of events that have been classified as fraudulent. The number of events that are evaluated by the payment server 130 can be pre-specified. For example, the payment server 130 can process a pre-specified number of events associated with the entity and calculate the percentage of events that were classified as fraudulent. If the percentage of the fraudulent events exceeds a pre-specified threshold, the payment server 130 can determine that the entity i.e., the merchant's website and potentially the merchant server 120 have been compromised thus determining a security event experienced by the entity.

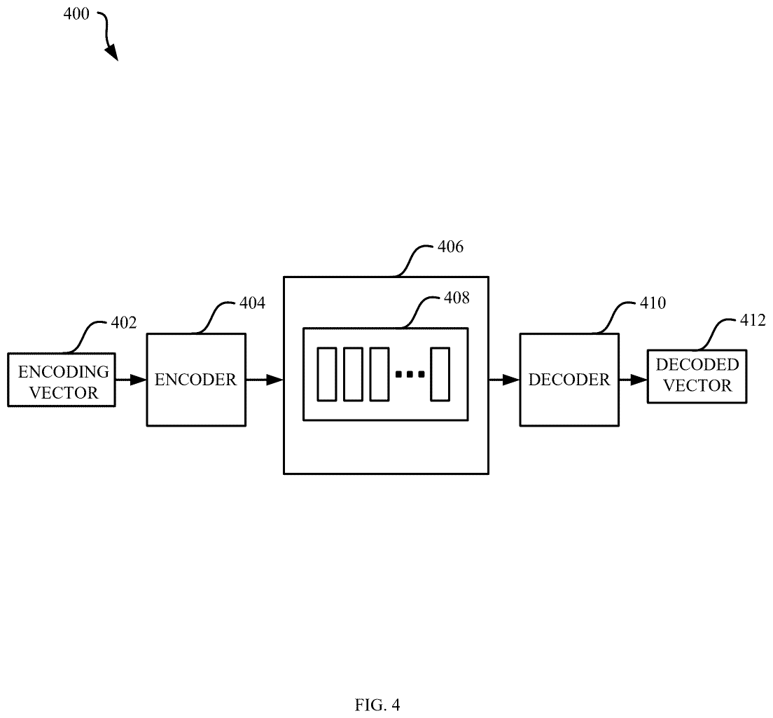

FIG. 4 is a block diagram illustrating a second ML model 208B implemented by the payment server 130 for generating discretized vector representations. FIG. 4 shows an encoding vector 402 generated by the first ML model 208A that is provided as input to the encoder 404 of the second ML model 208B. The encoder 404 can be a neural network block that includes multiple neural network layers. The payment server 130 can process the encoding vector 402 though the non-linearity of each of the multiple neural network layers of the encoder 404 to generate a latent vector. The payment server 130 can provide the latent vector to a vector quantization layer 406 that includes a codebook 408 which includes a set of fixed-size vectors each of which can represent a discrete state in the latent space. The payment server 130 can select a codebook vector from the codebook 408 based on the least distance (e.g., Euclidean) from the latent vector which can be used by the payment server 130 to determine whether an entity is experiencing a security event.

During the training process, the payment server 130 provides training samples from the event dataset to the first ML model 208 to generate respective encodings. The payment server 130 then provides the encodings to the encoder 404 of the second ML model 208B to generate corresponding latent vectors. The payment server 130 then selects the corresponding codebook vectors from the codebook 406 and provides the codebook vectors as input to the decoder 410. The decoder 410 can be a neural network block that includes multiple neural network layers that process the selected codebook vector to generate a decoded vector 412. To train the second ML model 208B, the payment server 130 can compute the reconstruction error based on the encoding vector 402 and the decoded vector 412 and adjusts the trainable parameters of the encoder 404, the codebook vectors 408 and the decoder 408 to minimize the reconstruction error.

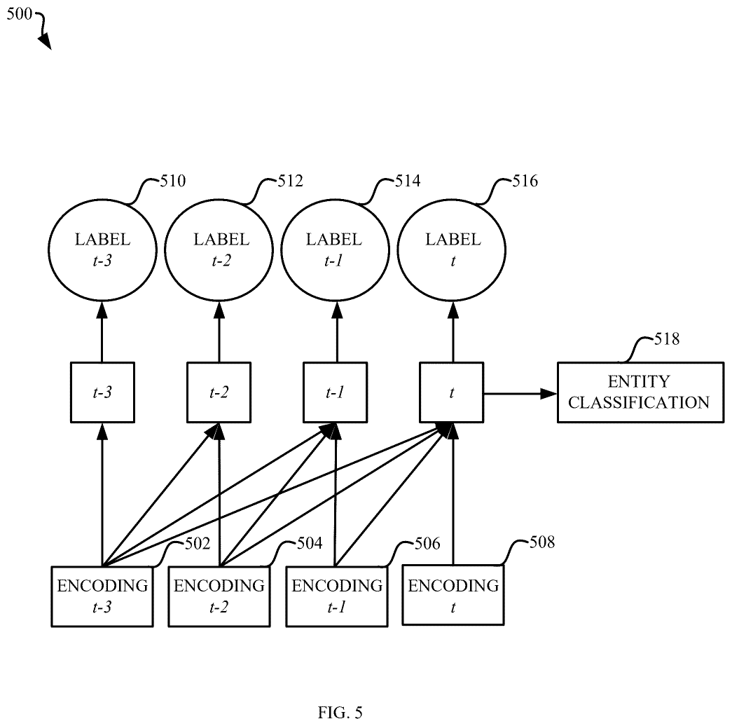

FIG. 5 is a block diagram illustrating a second ML model 208B implemented by the payment server 130 for determining whether an entity is experiencing a security event based on sequential classification of events. FIG. 5 shows encodings 502-508 generated by the first ML model 208A for timestamps t-3 to t, respectively. As described before, these encodings are compressed representations of the first set of features and the second set of predicted features generated by the payment server 130. With reference to the example provided with reference to FIG. 3A, the first set of features 302 includes the transaction amount, timestamp, bank identification number (BIN), merchant category, and IP address of the user device 110 and the second set of predicted features 306 includes the customer browser type, the time to complete the transaction, the corporate card indicator, the visibility status of the transaction, etc. The payment server 130 can process the first set of features 302 using the sub model 304 to generate the second set of features 306. The payment server 130 can then process the first set of features 302 and the second set of features 306 using the sub model 308 to generate the encoding 310.

While generating a classification for a particular event, the second ML model 208B can process the encodings of the one or more prior events. For example, while generating a classification label for an event with timestamp t-2, the payment server 130 uses the encoding 504 generated by the first ML model 208A and the encodings 502 generated for the event at timestamp t-3. By doing so, the payment server 130 can classify the events as legitimate or fraudulent based on prior events. Since card testing attacks involves a bulk of fraudulent transactions, the payment server 130 can exploit the temporal dependency of prior fraudulent events to classify a subsequent transaction. As for another example, while generating a label for an event with timestamps t-1, the payment server 130 can use the encodings 506 along with the encodings 504 and 502. In this example, assume that the pre-specified threshold for proportion of events needed to determine that the entity is experiencing a security event is 50%. If the payment server 130 classifies at least three out of the four events as fraudulent, the payment server 130 can determine that the entity is experiencing a security event. For example, the payment server 130 uses the second ML model 208B to classify the events at timestamp t-3, t-1, and t as fraudulent. Since three out of four events were classified as fraudulent, the payment server 130 can classify the entity as experiencing a security event. For example, the payment server 130 can generate a label 518 (e.g., “under security event” or “no security event”) to indicate the determined classification.

FIG. 6 is a flowchart illustrating an example process 600 of using a first ML model 208 and a second ML model 208B to determine a security event. For explanatory purposes, the process 600 is primarily described herein with reference to the user device 110, the merchant server 120 and the payment server 130 of FIG. 1. However, the process 600 is not limited to the user device 110, the merchant server 120 and the payment server 130 of FIG. 1, and one or more blocks (or operations) of the process 600 may be performed by one or more other suitable devices. Further for explanatory purposes, the blocks of the process 600 are described herein as occurring in serial, or linearly. However, multiple blocks of the process 600 may occur in parallel. In addition, the blocks of the process 600 need not be performed in the order shown and/or one or more blocks of the process 600 need not be performed and/or can be replaced by other operations.

At block 602, the payment server 130 obtains a plurality of event data items from the merchant server 120. When a customer initiates an event such as payment transaction using one or more payments methods such as debit and/or credit cards on the merchant website, the merchant server 120 captures the event data item for each individual event. The event data item can include for example, an amount, a date, a time, merchant details, along with sensitive customer data like card number, security codes, etc. The event data items are then securely transmitted to the transaction processing system of the payment server 130 using encryption methods and secure communication protocols. As an example, the merchant server 120 can transmit four event data items to the payment server 130 where each event data item can include information such as transaction amount, timestamp, bank identification number (BIN), merchant category, geographical location, data identifying the user device 110, IP address etc.

At block 604, the payment server 130 uses the first ML model 208A to predict missing features and generate an encoding. The payment server 130 processes the event data items to extract the first set of features. For example, the first set of features can include the transaction amount, timestamp, bank identification number (BIN), merchant category, and IP address of the user device 110. The payment server 130 then uses the first ML model 208A to process the first set of features to generate the second set of predicted features. The second set of predicted features can include one or more features that were either missing from the array of features or one or more refined features that are derived from the first set of features such as transaction velocity, spending patterns, etc. For example, the second set of predicted features can include customer browser type, time to complete the transaction, corporate card indicator, visibility status of the transaction, etc.

After generating the first set of features and the second set of predicted features, the first ML model may further process the features to generate an encoding. For example, the first ML model 208A can process the first set of features and the second set of predicted features to transform the first set of features and the second set of predicted features into an encoding. To continue with the example described above, the payment server 130 can generate the second set of predicted features for each of the four events and generate a respective encoding for each of the four events.

At block 606, the payment server 130 uses the second ML model 208B to generate a classification indicating whether the event is legitimate or fraudulent. For example, the second ML model 208B can process the encodings generated by the first ML model 208A to classify the encodings as fraudulent or legitimate. By doing so, the second ML model 208B determines whether the transaction associated with the encodings are fraudulent or legitimate transactions. While generating a classification for a particular event, the second ML model 208B can also process the encodings generated for the one or more prior events. For example, if there are five events, and the second ML model 208B is processing the encoding of the third event, the second ML model 208B can also process the encodings generated for the previous two events. In some implementations, the second ML model 208B can process the encodings generated for each of the prior events for classifying the current event as legitimate or fraudulent. In other implementations, the number of prior classifications that can be used by the second ML model 208B is pre-specified. For example, if the pre-specified number is set to 1, the second ML model 208B can use the classification of only the prior event. Continuing with the example described above, the payment server 130 can use the second ML model 208B to process the encodings generated for the four events and classify the four events as legitimate or fraudulent events. For example, while generating a classification for the second event, the payment server 130 can process the encoding generated for the second event along with the encoding generated for the first event. Similarly, while generating the classification for the third event, the payment server 130 can process the encoding for the third events along with the encodings generated for the second and first event, respectively.

At block 608, the payment server 130 determines whether the entity is experiencing a security event. The payment server 130 can determine whether the merchant is experiencing a security event by analyzing the classifications generated by the second ML model 208B for a sequence of events. The payment server 130 can calculate a proportion of events that were classified as fraudulent. For example, the proportion of events that are classified as fraudulent can be calculated as a percentage of events. For example, the payment server 130 can processes a pre-specified number of events associated with the merchant and calculate the percentage of events that were classified as fraudulent. If the percentage of the fraudulent events exceeds a pre-specified threshold, the payment server 130 can determine that the entity i.e., the merchant's website (e.g., which may be published by the merchant server 120) and potentially the merchant server 120 is compromised thus identifying a security event experienced by the entity. Continuing with the example described above, the payment server 130 can calculate a proportion of events that were classified as fraudulent. For example, if the pre-specified threshold for proportion of events needed to determine that the entity is experiencing a security event is 50% and the payment server 130 classifies at least three out of the four events as fraudulent, the payment server 130 can determine that the entity is experiencing a security event.

At block 610, the payment server 130 adjusts the event processing rate in response to determining that the entity is experiencing a security event. For example, the payment server 130 may reduce the rate of transaction processing from the entity to undermine the security event. For example, if the merchant server 120 is transmitting 10 transactions per second for an entity and if the payment server 130 determines that the entity is experiencing a security event, the payment server 130 can reduce the transaction processing rate to 1 transactions per second. In response to determining that an entity is experiencing a security event, the payment server 130 can also implement other types of restrictions to prevent the security event. For example, the payment server 130 can determine whether the fraudulent events are submitted by bots or scripts based on the first set of features and the second set of features and in response the payment server 130 can block further events and notify the entity. Continuing with the example described above, in response to determining that the entity is experiencing a security event, the payment server 130 can adjust the payment processing rate of the entity. For example, if the merchant server 120 transmits ten event data items every second, and the payment server 130 is processing ten events every second, the payment server 130 can reduce the rate of transaction processing from ten events per second to 3 events per second for the entity to mitigate the security event.

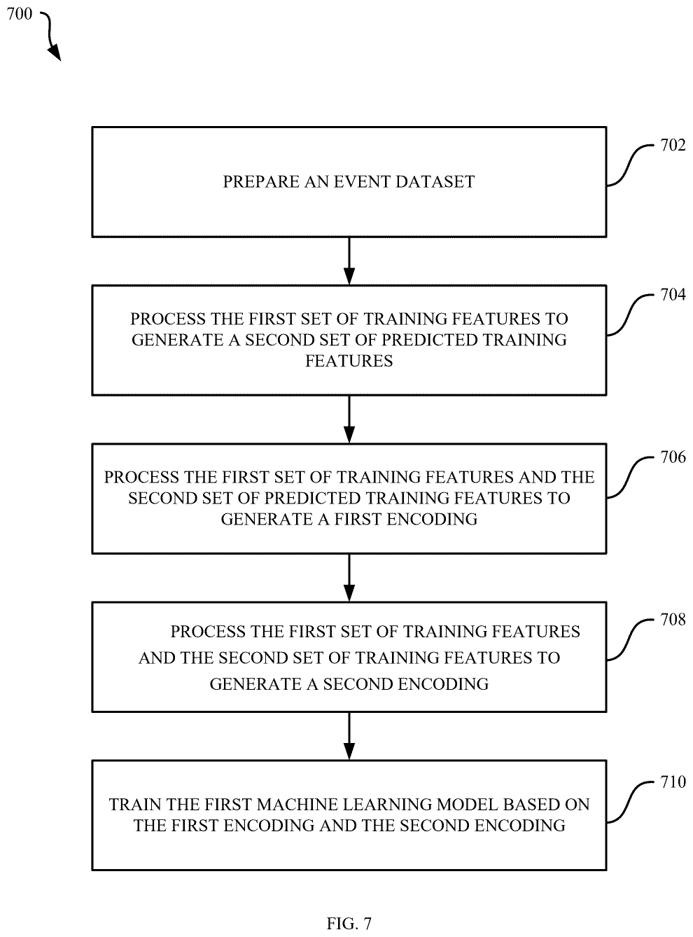

FIG. 7 is a flowchart illustrating an example process 700 of training the first ML model 208A. For explanatory purposes, the process 700 is primarily described herein with reference to the user device 110, the merchant server 120 and the payment server 130 of FIG. 1. However, the process 700 is not limited to the user device 110, the merchant server 120 and the payment server 130 of FIG. 1, and one or more blocks (or operations) of the process 700 may be performed by one or more other suitable devices. Further for explanatory purposes, the blocks of the process 700 are described herein as occurring in serial, or linearly. However, multiple blocks of the process 700 may occur in parallel. In addition, the blocks of the process 700 need not be performed in the order shown and/or one or more blocks of the process 700 need not be performed and/or can be replaced by other operations.

At block 702, the payment server 130 prepares an event dataset that includes a plurality of training samples each of which includes a first set of training features and a second set of training features. The payment server 130 can obtain multiple event data items from the merchant server 120. The payment server 130 can then catalog each event data to generate the event dataset. To generate the event dataset, the payment server 130 can extract a first set of training features from the event data items. For example, payment server 130 can extract the transaction amount, the timestamp, the bank identification number (BIN), the merchant category, the IP address of the user device 110, etc., and include them into the first set of features. Since these events correspond to historical transactions, the payment server 130 can obtain a second set of training features from one or more other sources such as the merchant server 120, the card network etc. If the second set of training features include derived features from the first set of features, the merchant server 120 can process the first set of training features to generate the second set of training features. Each training sample also includes a timestamp indicating the timestamp of the event and a label indicating whether the corresponding event was legitimate or fraudulent. As an example, the payment server 130 can generate an event dataset by storing one million event data items. The payment server 130 can process each of the one million event data items to generate a corresponding first set of training features that includes the transaction amount, timestamp, bank identification number (BIN), merchant category, and IP address of the user device 110. The payment server 130 can then obtain a second set of training features that includes a customer browser type, a time to complete the transaction, a corporate card indicator, a visibility status of the transaction, etc., from sources such as the merchant server 120, the card network etc.

At block 704, the payment server 130 processes the first set of training features using the first ML model 208A to generate missing features. For example, the payment server 130 may iteratively provide the first set of training features of the training samples to the first ML model 208A to generate a corresponding second set of predicted training features. Continuing with above example, the payment server 130 can process the first set of training features of each of the one million events of the event dataset to generate a corresponding second set of predicted training features. The second set of predicted training features can include the same features as the second set of features i.e., a customer browser type, a time to complete the transaction, a corporate card indicator, a visibility status of the transaction, etc.

At block 706, the payment server 130 generates a first encoding. For example, the payment server 130 can use the first ML model 208A to process the first set of training features and the second set of predicted training features of each of the one million events of the event dataset to generate a corresponding first encoding.

At block 708, the payment server 130 generates a second encoding. For example, the payment server 130 uses the first ML model 208A to process the first set of training features and the second set of training features of each of the one million events of the event dataset to generate a corresponding second encoding.

At block 710, the payment server 130 adjusts the parameters of the first ML model 208A. For example, the payment server 130 can compare the first encoding and the second encoding and compute a loss value based on a loss function (e.g., Cross-entropy loss function) and alter the parameters of the first ML model 208A based on the loss value. The payment server 130 may repeat the process iteratively using different training samples from the event dataset until the loss value is below a certain pre-threshold. The training can further include fine tuning that involves adjusting hyperparameters, extending the training duration or enriching the training data set with more diverse examples. Continuing with above example, the payment server 130 can execute the steps of block 706-710 iteratively during the training process. For example, during each iteration of the training process, the payment server 130 can select a training sample from the event dataset and generate a first encoding and a second encoding. The payment server 130 can compute a loss value based on a loss function and alter the parameters of the first ML model 208A based on the loss value. The payment server 130 can iterate through the one million events of the event dataset until the loss value is below a pre-specified threshold.

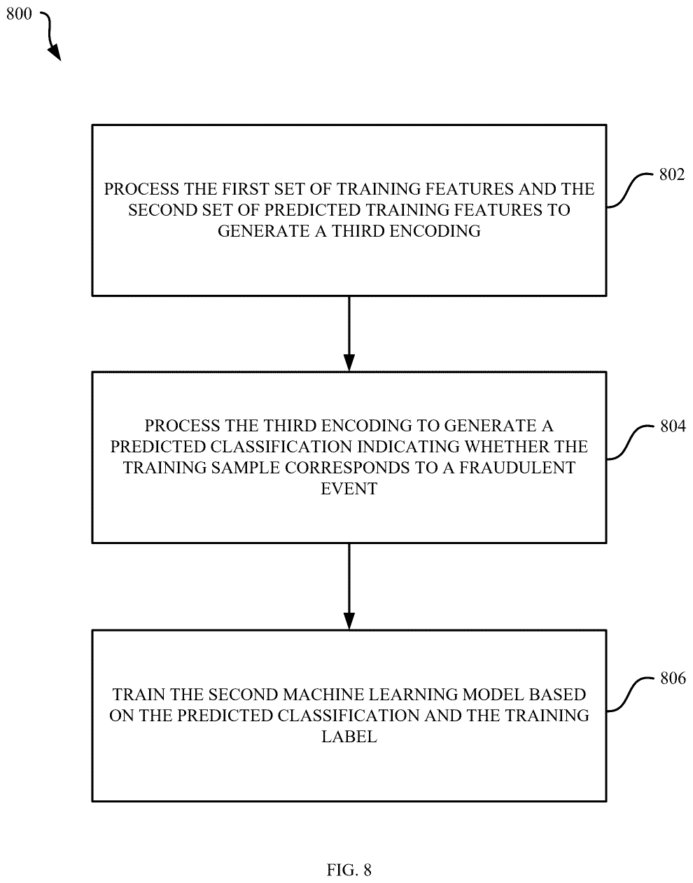

FIG. 8 is a flowchart illustrating an example process 800 of training the second ML model 208B. For explanatory purposes, the process 800 is primarily described herein with reference to the user device 110, the merchant server 120 and the payment server 130 of FIG. 1. However, the process 800 is not limited to the user device 110, the merchant server 120 and the payment server 130 of FIG. 1, and one or more blocks (or operations) of the process 800 may be performed by one or more other suitable devices. Further for explanatory purposes, the blocks of the process 800 are described herein as occurring in serial, or linearly. However, multiple blocks of the process 800 may occur in parallel. In addition, the blocks of the process 800 need not be performed in the order shown and/or one or more blocks of the process 800 need not be performed and/or can be replaced by other operations.

At block 802, the payment server 130 generates an encoding using the first set of training features and the second set of predicted training features. For example, the payment server 130 can iteratively provide the first set of training features and the corresponding second set of predicted training features to the trained first ML model 208A to generate a third encoding.

At block 804, the payment server 130 generates a classification indicating whether the training sample corresponds to a fraudulent event. For example, the payment server 130 can process the third encoding using a second ML model to generate a predicted classification indicating whether the third encoding corresponds to an event that is legitimate or fraudulent. For example, the second ML model 208B can generate a label by processing the third encoding. In an example, the labels can be “fraudulent” or “legitimate.” The payment server 130 can also process the third encoding along with the third encoding generated for one or more prior events. As an example, while generating a classification for a training sample with a time stamp t, the second ML model 208B can process the third encoding of the training sample along with the third encoding generated for training sample for the t-1 timestamp.

At block 806, the payment server 130 trains the second ML model 208B. For example, the payment server 130 can compare the predicted classification i.e., the predicted label by the second ML model 208B with the label from the training sample to compute a loss value based on a loss function (e.g., Binary cross-entropy loss function) and alter the parameters of the second ML model 208B based on the loss value. The training also includes providing the loss value as a feedback to the second ML model 208B and adjust the trainable parameters of the second ML model 208B. The payment server 130 may repeat the process iteratively using different training samples from the event dataset until the loss value is below a certain pre-threshold. The training can further include fine tuning that involves adjusting hyperparameters, extending the training duration or enriching the training data set with more diverse examples. Continuing with the example described with reference to FIG. 7, the payment server 130 can iteratively execute the steps of the blocks 802-806 during the training process. For example, during each iteration of the training process, the payment server 130 can select a training sample from the event dataset and use the first ML model 208A to process the first set of training features and the corresponding second set of predicted training features to generate a third encoding. The payment server 130 can process the third encoding using the second ML model 208B to classify the event of the selected training sample as legitimate or fraudulent. The payment server 130 can then compare the label of the predicted classification to the label from the selected training sample to compute a loss value and alter the parameters of the second ML model 208B. The payment server 130 can iterate through the one million events or the event dataset until the loss value is below a pre-specified threshold.

After training the first ML model 208A and the second ML model 208B, the payment server 130 can use the first ML model 208A and the second ML model 208B to process large volumes of transactions for achieving high-throughput. Compared to traditional rule-based or heuristic methods, which often require extensive memory storage to store rules, patterns and numerous intermediate computations, the payment server 130 can use compression techniques to lower the memory requirement by reducing the size of the configuration files of the first ML model 208A and the second ML model 208B without sacrificing accuracy and speed, thereby providing efficient use of memory and/or power resources.

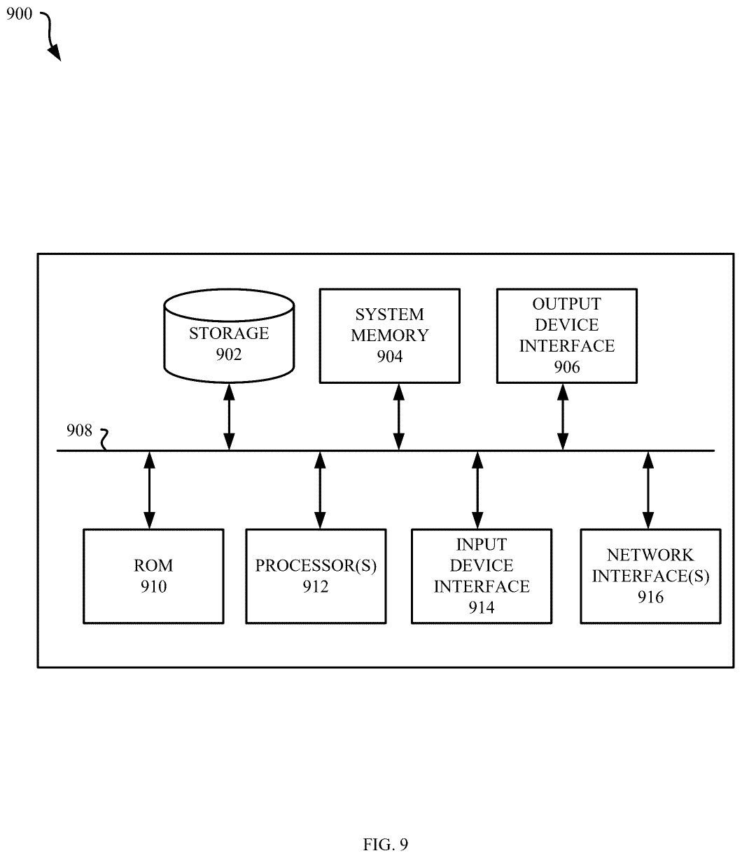

FIG. 9 illustrates an electronic system 900 with which one or more implementations of the subject technology may be implemented. The electronic system 900 can be, and/or can be a part of, the merchant server 120, the payment server 130 and/or user device 110 shown in FIG. 1. The electronic system 900 may include various types of computer readable media and interfaces for various other types of computer readable media. The electronic system 900 includes a bus 908, one or more processing unit(s) 912, a system memory 904 (and/or buffer), a ROM 910, a permanent storage device 902, an input device interface 914, an output device interface 906, and one or more network interfaces 916, or subsets and variations thereof.

The bus 908 collectively represents all system, peripheral, and chipset buses that communicatively connect the numerous internal devices of the electronic system 900. In one or more implementations, the bus 908 communicatively connects the one or more processing unit(s) 912 with the ROM 910, the system memory 904, and the permanent storage device 902. From these various memory units, the one or more processing unit(s) 912 retrieves instructions to execute and data to process in order to execute the processes of the subject disclosure. The one or more processing unit(s) 912 can be a single processor or a multi-core processor in different implementations.

The ROM 910 stores static data and instructions that are needed by the one or more processing unit(s) 912 and other modules of the electronic system 900. The permanent storage device 902, on the other hand, may be a read-and-write memory device. The permanent storage device 902 may be a non-volatile memory unit that stores instructions and data even when the electronic system 900 is off. In one or more implementations, a mass-storage device (such as a magnetic or optical disk and its corresponding disk drive) may be used as the permanent storage device 902.

In one or more implementations, a removable storage device (such as a floppy disk, flash drive, and its corresponding disk drive) may be used as the permanent storage device 902. Like the permanent storage device 902, the system memory 904 may be a read-and-write memory device. However, unlike the permanent storage device 902, the system memory 904 may be a volatile read-and-write memory, such as random-access memory. The system memory 904 may store any of the instructions and data that one or more processing unit(s) 912 may need at runtime. In one or more implementations, the processes of the subject disclosure are stored in the system memory 904, the permanent storage device 902, and/or the ROM 810. From these various memory units, the one or more processing unit(s) 912 retrieves instructions to execute and data to process in order to execute the processes of one or more implementations.

The bus 908 also connects to the input and output device interfaces 914 and 906. The input device interface 914 enables a user to communicate information and select commands to the electronic system 900. Input devices that may be used with the input device interface 814 may include, for example, alphanumeric keyboards and pointing devices (also called “cursor control devices”). The output device interface 906 may enable, for example, the display of images generated by electronic system 900. Output devices that may be used with the output device interface 906 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information. One or more implementations may include devices that function as both input and output devices, such as a touchscreen. In these implementations, feedback provided to the user can be any form of sensory feedback, such as visual feedback, auditory feedback, or tactile feedback; and input from the user can be received in any form, including acoustic, speech, or tactile input.

Finally, as shown in FIG. 9, the bus 908 also couples the electronic system 900 to one or more networks and/or to one or more network nodes, such as the user device 110, the merchant server 120 and the payment server 130 shown in FIG. 1, through the one or more network interface(s) 916. In this manner, the electronic system 900 can be a part of a network of computers (such as a LAN, a wide area network (“WAN”), or an Intranet, or a network of networks, such as the Internet. Any or all components of the electronic system 900 can be used in conjunction with the subject disclosure.

Implementations within the scope of the present disclosure can be partially or entirely realized as computer program products comprising code in a tangible computer-readable storage medium (or multiple tangible computer-readable storage media of one or more types) encoding one or more instructions of the code. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more implementations, the tangible computer-readable storage medium can be directly coupled to a computing device, while in other implementations, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessor or multi-core processors that execute software, one or more implementations are performed by one or more integrated circuits, such as ASICs or FPGAs. In one or more implementations, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or segmented in a different way) all without departing from the scope of the subject technology.

Aspects of the present technology may include the gathering and use of data available from specific and legitimate sources to train machine learning models and to apply to trained machine learning models deployed in systems. The present disclosure contemplates that in some instances, this gathered data may include personal information data that uniquely identifies or can be used to identify a specific person. Such personal information data can include meta-data or other data associated with images that may include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to train a machine learning model for better performance. Accordingly, use of such personal information data enables users to have greater control of the delivered content. Further, other uses for personal information data that benefit the user are also contemplated by the present disclosure.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are recognized as meeting or exceeding industry or governmental requirements for maintaining the privacy of users. Such information regarding the use of personal data should be prominently and easily accessible by users and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations which may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates implementations in which users selectively block the use of, or access to, personal information data. That is, the present disclosure contemplates that hardware and/or software elements can be provided to prevent or block access to such personal information data. For example, in the case of training data collection, the present technology can be configured to allow users to select to “opt in” or “opt out” of participation in the collection of personal information data during registration for services or anytime thereafter. In another example, users can select not to provide mood-associated data for use as training data. In yet another example, users can select to limit the length of time mood-associated data is maintained or entirely block the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed implementations, the present disclosure also contemplates that the various implementations can also be implemented without the need for accessing such personal information data. That is, the various implementations of the present technology are not rendered inoperable due to the lack of all or a portion of such personal information data. For example, training data can be selected based on aggregated non-personal information data or a bare minimum amount of personal information, such as the content being handled only on the user's device or other non-personal information available to as training data.

It is understood that any specific order or hierarchy of blocks in the processes disclosed is an illustration of example approaches. Based upon design preferences, it is understood that the specific order or hierarchy of blocks in the processes may be rearranged, or that all illustrated blocks be performed. Any of the blocks may be performed simultaneously. In one or more implementations, multitasking and parallel processing may be advantageous. Moreover, the separation of various system components in the implementations described above should not be understood as requiring such separation in all implementations, and it should be understood that the described program components and systems can be integrated together in a single software product or packaged into multiple software products.

As used in this specification and any claims of this application, the terms “base station,” “receiver,” “computer,” “server,” “processor,” and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The predicate words “configured to,” “operable to,” and “programmed to” do not imply any particular tangible or intangible modification of a subject, but, rather, are intended to be used interchangeably. In one or more implementations, a processor configured to monitor and control an operation, or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some implementations, one or more implementations, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other implementations. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A computer-implemented method comprising:
obtaining a plurality of event data items corresponding to a plurality of events;
processing each event data item of the plurality of event data items using a first machine learning (ML) model to generate an encoding for each corresponding event data item;
detecting a security event based at least in part on the generated encodings, wherein the detecting comprises:
processing each encoding for each event data item using a second ML model to generate a classification of whether the event is fraudulent; and
determining the security event based at least in part on at least some of the classifications; and
in response to detecting the security event, adjusting an event processing rate.

2. The computer-implemented method of claim 1, wherein each event data item comprises a first set of features associated with the corresponding event.

3. The computer-implemented method of claim 2, wherein generating the encoding for each corresponding event data item comprises:
processing the first set of features using the first ML model to generate a second set of predicted features, wherein the first set of features and the second set of predicted features are mutually exclusive; and
processing the first set of features and the second set of predicted features using the first ML model to generate the encoding.

4. The computer-implemented method of claim 1, wherein each event is associated with a timestamp, and wherein the classification of a subsequent event is based on the encoding generated for a prior event of the plurality of events based on timestamps associated with the corresponding event.

5. The computer-implemented method of claim 1, wherein determining the security event comprises determining a percentage of some of the events that were classified as fraudulent.

6. The computer-implemented method of claim 5, wherein determining the security event comprises determining whether the percentage of the events that were classified as fraudulent is more than a threshold limit.

7. The computer-implemented method of claim 1, wherein the first ML model is a generative model and wherein training the first ML model comprises:
preparing an event dataset comprising of a plurality of training samples, wherein each training sample comprises a first set of training features and a second set of training features, and wherein each training sample is associated with a training timestamp and a training label indicating whether the training sample corresponds to a fraudulent event;
processing the first set of training features using the first ML model to generate a second set of predicted training features;
processing the first set of training features and the second set of predicted training features using the first ML model to generate a first encoding;
processing the first set of training features and the second set of training features using the first ML model to generate a second encoding; and
adjusting a plurality of parameters of the first ML model based on the first encoding and the second encoding.

8. The computer-implemented method of claim 7, wherein the second ML is a classification model and wherein training the second ML model comprises:
processing the first set of training features and the second set of predicted training features using the first ML model to generate a third encoding;
processing the third encoding using a second ML model to generate a predicted classification indicating whether the training sample corresponds to a fraudulent event; and
adjusting a plurality of parameters of the second ML model based on the predicted classification and the training label associated with the training sample.

9. The computer-implemented method of claim 1, wherein detecting the security event comprises:
processing each encoding for each event data item using a second ML model to generate a respective vector representation;
selecting a latent vector for each vector representation based on a distance between the respective vector representations and the selected latent vector;
determining an entropy for each of the selected latent vectors; and
determining the security event based at least in part on the entropy determined for at least one of the selected latent vectors.

10. A computer system, comprising:
one or more processors; and
memory storing one or more programs configured to be executed by the one or more processors to perform operations comprising:
obtaining a plurality of event data items corresponding to a plurality of events;
processing each event data item of the plurality of event data items using a first machine learning (ML) model to generate an encoding for each corresponding event data item;
detecting a security event based at least in part on the generated encodings, wherein the detecting comprises:
processing each encoding for each event data item using a second ML model to generate a classification of whether the event is fraudulent, and
determining the security event based at least in part on at least some of the classifications; and
in response to detecting the security event, adjusting an event processing rate.

11. The computer system of claim 10, wherein each event data item comprises a first set of features associated with the corresponding event.

12. The computer system of claim 11, wherein generating the encoding for each corresponding event data item comprises:
processing the first set of features using the first ML model to generate a second set of predicted features, wherein the first set of features and the second set of predicted features are mutually exclusive; and
processing the first set of features and the second set of predicted features using the first ML model to generate the encoding.

13. The computer system of claim 10, wherein each event is associated with a timestamp, and wherein the classification of a subsequent event is based on the encoding generated for a prior event of the plurality of events based on timestamps associated with the corresponding event.

14. The computer system of claim 10, wherein determining the security event comprises determining a percentage of some of the events that were classified as fraudulent.

15. The computer system of claim 10, wherein the first ML model is a generative model and wherein training the first ML model comprises:
preparing an event dataset comprising of a plurality of training samples, wherein each training sample comprises a first set of training features and a second set of training features, and wherein each training sample is associated with a training timestamp and a training label indicating whether the training sample corresponds to a fraudulent event;
processing the first set of training features using the first ML model to generate a second set of predicted training features;
processing the first set of training features and the second set of predicted training features using the first ML model to generate a first encoding;
processing the first set of training features and the second set of training features using the first ML model to generate a second encoding; and
adjusting a plurality of parameters of the first ML model based on the first encoding and the second encoding.

16. The computer system of claim 10, wherein detecting the security event comprises:
processing each encoding for each event data item using a second ML model to generate a respective vector representation;
selecting a latent vector for each vector representation based on a distance between the respective vector representations and the selected latent vector;
determining an entropy for each of the selected latent vectors; and
determining the security event based at least in part on the entropy determined for at least one of the selected latent vectors.

17. A non-transitory computer-readable storage medium storing one or more programs configured to be executed by one or more processors of a computer system, the one or more programs including instructions for:
obtaining a plurality of event data items corresponding to a plurality of events;
processing each event data item of the plurality of event data items using a first machine learning (ML) model to generate an encoding for each corresponding event data item;
detecting a security event based at least in part on the generated encodings, wherein the detecting comprises:
processing each encoding for each event data item using a second ML model to generate a classification of whether the event is fraudulent, and
determining the security event based at least in part on at least some of the classifications; and
in response to detecting the security event, adjusting an event processing rate.

18. The non-transitory computer-readable storage medium of claim 17, wherein each event is associated with a timestamp, and wherein the classification of a subsequent event is based on the encoding generated for a prior event of the plurality of events based on timestamps associated with the corresponding event.

19. The non-transitory computer-readable storage medium of claim 17, wherein the first ML model is a generative model and wherein training the first ML model comprises:
preparing an event dataset comprising of a plurality of training samples, wherein each training sample comprises a first set of training features and a second set of training features, and wherein each training sample is associated with a training timestamp and a training label indicating whether the training sample corresponds to a fraudulent event;
processing the first set of training features using the first ML model to generate a second set of predicted training features;
processing the first set of training features and the second set of predicted training features using the first ML model to generate a first encoding;
processing the first set of training features and the second set of training features using the first ML model to generate a second encoding; and
adjusting a plurality of parameters of the first ML model based on the first encoding and the second encoding.

20. The non-transitory computer-readable storage medium of claim 19, wherein the second ML is a classification model and wherein training the second ML model comprises:
processing the first set of training features and the second set of predicted training features using the first ML model to generate a third encoding;
processing the third encoding using a second ML model to generate a predicted classification indicating whether the training sample corresponds to a fraudulent event; and
adjusting a plurality of parameters of the second ML model based on the predicted classification and the training label associated with the training sample.
